(19) United States
(12) Patent Application Publication
(10) Pub. No.: US 2026/0222252 A1
(43) Pub. Date: Jul. 30, 2026

(54) TECHNIQUES FOR COMMUNICATING WITH PASSIVE DEVICES USING MULTIPLEXED WAVEFORMS

(71) Applicant: QUALCOMM Incorporated, San Diego, CA (US)

(72) Inventors: Mingxi YIN, Beijing (CN); Chao WEI, Beijing (CN); Min HUANG, Beijing (CN); Kangqi LIU, San Diego, CA (US); Ruiming ZHENG, Beijing (CN); Hao XU, Beijing (CN)

(21) Appl. No.: 19/151,924

(22) PCT Filed: Mar. 15, 2023
(86) PCT No.: PCT/CN2023/081500

§ 371 Date: Jul. 29, 2025

(51) Int. Cl. H04L 27/08; H04L 1/00; H04W 72/0446

(52) U.S. Cl. CPC H04L 27/08; H04L 1/0003; H04W 72/0446

(57) ABSTRACT

Methods, systems, and devices for wireless communications are described. A first wireless device may generate a multiplexed waveform by multiplexing a first transmission for a passive device (e.g., a radio frequency identifier (RFID) tag) together with a second transmission for a second wireless device. The first wireless device may modulate the first transmission according to a first modulation scheme and may modulate the second transmission according to a second modulation scheme. The first wireless device may provide the second wireless device with information about a set of modulation symbols of the first transmission. The information may include one or more reference signals, an indication of a sequence corresponding to the set of modulation symbols, an indication of a transmit power for one or more of the modulation symbols, or a combination thereof. The second wireless device may use the information to demodulate and decode the multiplexed waveform.

### CROSS REFERENCE

The present application is a 371 national phase filing of International PCT Application No. PCT/CN2023/081500 by YIN et al., entitled “TECHNIQUES FOR COMMUNICATING WITH PASSIVE DEVICES USING MULTIPLEXED WAVEFORMS,” filed Mar. 15, 2023, which is assigned to the assignee hereof, and which is expressly incorporated by reference in its entirety herein.

### TECHNICAL FIELD

The following relates to wireless communications, including techniques for communicating with passive devices using multiplexed waveforms.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include passive devices, such as radio frequency identifier (RFID) tags or passive Internet-of-Things (IoT) devices, to perform certain operations such as location tracking and identification. To communicate with a passive device, a querying device (e.g., UE, network entity) transmits a signal or query to the passive device to instruct the passive device to perform a read or write operation, and the passive device may harvest energy from the signal or query to perform the read or write operation or respond to the querying device. Passive devices such as RFID tags may include relatively low-complexity devices with limited resources and processing power.

### SUMMARY

The described techniques relate to improved methods, systems, devices, and apparatuses that support techniques for communicating with passive devices using multiplexed waveforms. For example, the described techniques provide for a first wireless device to generate a multiplexed waveform by multiplexing a first transmission for a passive device together with a second transmission for a second wireless device. The first wireless device may modulate the first transmission according to a first modulation scheme and may modulate the second transmission according to a second modulation scheme. To enable the second wireless device to successfully decode and demodulate the multiplexed waveform, the first wireless device may provide the second wireless device with information about the first transmission (e.g., intended for the passive device).

For example, the first wireless device may transmit, to the second wireless device, an indication of a sequence corresponding to a set of modulation symbols of the first transmission, an indication of a transmit power for one or more modulations of the set of modulation symbols, or a combination thereof. Additionally, or alternatively, the first wireless device may include one or more reference signals, such as phase tracking reference signals (PT-RSs), associated with the set of modulation symbols in the multiplexed waveform for the second wireless device to use in demodulation and decoding. In another example, the first wireless device may transmit a preemption indication for the multiplexed waveform to the second wireless device such that the second wireless device refrains from using the set of modulation symbols during decoding procedures (e.g., soft combining).

A method for wireless communications at a first wireless device is described. The method may include transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme and transmitting, in accordance with the indication, a multiplexed waveform including the first transmission according to the first modulation scheme multiplexed with at least a portion of the second transmission according to the second modulation scheme.

An apparatus for wireless communications at a first wireless device is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the first wireless device to transmit, to a second wireless device, an indication of a set of modulation symbols in a first transmission to a third wireless device using a first modulation scheme, where the first transmission is scheduled to at least partially overlap with a second transmission to the second wireless device using a second modulation scheme and transmit, in accordance with the indication, a multiplexed waveform including the first transmission according to the first modulation scheme multiplexed with at least a portion of the second transmission according to the second modulation scheme.

Another apparatus for wireless communications at a first wireless device is described. The apparatus may include means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme and means for transmitting, in accordance with the indication, a multiplexed waveform including the first transmission according to the first modulation scheme multiplexed with at least a portion of the second transmission according to the second modulation scheme.

A non-transitory computer-readable medium storing code for wireless communications at a first wireless device is described. The code may include instructions executable by at least one processor (e.g., directly, indirectly, after pre-processing, without pre-processing) to transmit, to a second wireless device, an indication of a set of modulation symbols in a first transmission to a third wireless device using a first modulation scheme, where the first transmission is scheduled to at least partially overlap with a second transmission to the second wireless device using a second modulation scheme and transmit, in accordance with the indication, a multiplexed waveform including the first transmission according to the first modulation scheme multiplexed with at least a portion of the second transmission according to the second modulation scheme.

In some examples of the method, apparatuses, and non-transitory computer-readable medium described herein, the indication may be transmitted prior to transmitting the multiplexed waveform.

In some examples of the method, apparatuses, and non-transitory computer-readable medium described herein, the first modulation scheme includes an OOK modulation scheme and the indication includes an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.

In some examples of the method, apparatuses, and non-transitory computer-readable medium described herein, the first modulation scheme includes an OOK modulation scheme and the indication includes a respective transmit power for each modulation symbol of the set of modulation symbols.

In some examples of the method, apparatuses, and non-transitory computer-readable medium described herein, the first modulation scheme includes an ASK modulation scheme and the indication includes an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

In some examples of the method, apparatuses, and non-transitory computer-readable medium described herein, the indication includes one or more pilot signals associated with one or more modulation symbols of the set of modulation symbols. Some examples of the method, apparatuses, and non-transitory computer-readable medium described herein may further include operations, features, means, or instructions for transmitting an indication of one or more time domain resources and one or more frequency domain resources for each of the one or more pilot signals, where the indication of the one or more time domain resources and one or more frequency domain resources may be transmitted prior to transmitting the indication of the set of modulation symbols in the first transmission. In some examples of the method, apparatuses, and non-transitory computer-readable medium described herein, the one or more pilot signals include one or more PT-RSs.

In some examples of the method, apparatuses, and non-transitory computer-readable medium described herein, the indication may be transmitted via a set of resources of a logical channel associated with indicating an OOK binary sequence for the set of modulation symbols and the set of resources includes a quantity of frequency domain resources that may be based on a quantity of symbols of the set of modulation symbols.

In some examples of the method, apparatuses, and non-transitory computer-readable medium described herein, the multiplexed waveform may be within a slot and the set of resources of the indication includes an initial time domain resource of the slot. In some examples of the method, apparatuses, and non-transitory computer-readable medium described herein, the multiplexed waveform may be within a first slot and the set of resources of the indication includes a final time domain resource of a second slot prior to the first slot.

In some examples of the method, apparatuses, and non-transitory computer-readable medium described herein, transmitting the indication may include operations, features, means, or instructions for transmitting DCI having a format associated with a preemption indication.

In some examples of the method, apparatuses, and non-transitory computer-readable medium described herein, transmitting the indication may include operations, features, means, or instructions for transmitting UCI having a format associated with a preemption indication.

In some examples of the method, apparatuses, and non-transitory computer-readable medium described herein, the third wireless device may be a passive device and the first wireless device may be a reader node associated with reading the passive device.

A method for wireless communications at a second wireless device is described. The method may include receiving, from a first wireless device, an indication of a set of modulation symbols in a first transmission to a third wireless device using a first modulation scheme, where the first transmission is scheduled to at least partially overlap with a second transmission to the second wireless device using a second modulation scheme and receiving, in accordance with the indication, a multiplexed waveform including the first transmission according to the first modulation scheme multiplexed with at least a portion of the second transmission according to the second modulation scheme.

An apparatus for wireless communications at a second wireless device is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the second wireless device to receive, from a first wireless device, an indication of a set of modulation symbols in a first transmission to a third wireless device using a first modulation scheme, where the first transmission is scheduled to at least partially overlap with a second transmission to the second wireless device using a second modulation scheme and receive, in accordance with the indication, a multiplexed waveform including the first transmission according to the first modulation scheme multiplexed with at least a portion of the second transmission according to the second modulation scheme.

Another apparatus for wireless communications at a second wireless device is described. The apparatus may include means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme and means for receiving, in accordance with the indication, a multiplexed waveform including the first transmission according to the first modulation scheme multiplexed with at least a portion of the second transmission according to the second modulation scheme.

A non-transitory computer-readable medium storing code for wireless communications at a second wireless device is described. The code may include instructions executable by at least one processor (e.g., directly, indirectly, after pre-processing, without pre-processing) to receive, from a first wireless device, an indication of a set of modulation symbols in a first transmission to a third wireless device using a first modulation scheme, where the first transmission is scheduled to at least partially overlap with a second transmission to the second wireless device using a second modulation scheme and receive, in accordance with the indication, a multiplexed waveform including the first transmission according to the first modulation scheme multiplexed with at least a portion of the second transmission according to the second modulation scheme.

In some examples of the method, apparatuses, and non-transitory computer-readable medium described herein, the indication may be received prior to receiving the multiplexed waveform.

In some examples of the method, apparatuses, and non-transitory computer-readable medium described herein, the first modulation scheme includes an OOK modulation scheme and the indication includes an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.

In some examples of the method, apparatuses, and non-transitory computer-readable medium described herein, the first modulation scheme includes an OOK modulation scheme and the indication includes a respective transmit power for each modulation symbol of the set of modulation symbols.

In some examples of the method, apparatuses, and non-transitory computer-readable medium described herein, the first modulation scheme includes an ASK modulation scheme and the indication includes an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

In some examples of the method, apparatuses, and non-transitory computer-readable medium described herein, the indication includes one or more pilot signals associated with one or more modulation symbols of the set of modulation symbols. Some examples of the method, apparatuses, and non-transitory computer-readable medium described herein may further include operations, features, means, or instructions for receiving an indication of one or more time domain resources and one or more frequency domain resources for each of the one or more pilot signals, where the indication of the one or more time domain resources and one or more frequency domain resources may be received prior to receiving the indication of the set of modulation symbols in the first transmission. Some examples of the method, apparatuses, and non-transitory computer-readable medium described herein may further include operations, features, means, or instructions for determining a transmit power of the one or more pilot signals and demodulating the second transmission according to the second modulation scheme based on the transmit power. In some examples of the method, apparatuses, and non-transitory computer-readable medium described herein, the one or more pilot signals include one or more PT-RSs.

In some examples of the method, apparatuses, and non-transitory computer-readable medium described herein, the indication may be received via a set of resources of a logical channel associated with indicating an OOK binary sequence for the set of modulation symbols and the set of resources includes a quantity of frequency domain resources that may be based on a quantity of modulation symbols of the set of modulation symbols.

In some examples of the method, apparatuses, and non-transitory computer-readable medium described herein, the multiplexed waveform may be within a slot and the set of resources of the indication includes an initial time domain resource of the slot. In some examples of the method, apparatuses, and non-transitory computer-readable medium described herein, the multiplexed waveform may be within a first slot and the set of resources of the indication includes a final time domain resource of a second slot prior to the first slot.

In some examples of the method, apparatuses, and non-transitory computer-readable medium described herein, receiving the indication may include operations, features, means, or instructions for receiving DCI having a format associated with a preemption indication.

In some examples of the method, apparatuses, and non-transitory computer-readable medium described herein, receiving the indication may include operations, features, means, or instructions for receiving UCI having a format associated with a preemption indication.

In some examples of the method, apparatuses, and non-transitory computer-readable medium described herein, the third wireless device may be a passive device and the first wireless device may be a reader node associated with reading the passive device.

### BRIEF DESCRIPTION OF THE DRAWINGS

FIG. 1 illustrates an example of a wireless communications system that supports techniques for communicating with passive devices using multiplexed waveforms in accordance with one or more aspects of the present disclosure.

FIG. 2 illustrates an example of a wireless communications system that supports techniques for communicating with passive devices using multiplexed waveforms in accordance with one or more aspects of the present disclosure.

FIG. 3 illustrates an example of a multiplexed waveform configuration that supports techniques for communicating with passive devices using multiplexed waveforms in accordance with one or more aspects of the present disclosure.

FIGS. 4A and 4B illustrate examples of slot configurations that support techniques for communicating with passive devices using multiplexed waveforms in accordance with one or more aspects of the present disclosure.

FIGS. 5 and 6 illustrate block diagrams of devices that support techniques for communicating with passive devices using multiplexed waveforms in accordance with one or more aspects of the present disclosure.

FIG. 7 illustrates a block diagram of a communications manager that supports techniques for communicating with passive devices using multiplexed waveforms in accordance with one or more aspects of the present disclosure.

FIG. 8 illustrates a diagram of a system including a UE that supports techniques for communicating with passive devices using multiplexed waveforms in accordance with one or more aspects of the present disclosure.

FIG. 9 illustrates a diagram of a system including a network entity that supports techniques for communicating with passive devices using multiplexed waveforms in accordance with one or more aspects of the present disclosure.

FIGS. 10 through 12 illustrate flowcharts showing methods that support techniques for communicating with passive devices using multiplexed waveforms in accordance with one or more aspects of the present disclosure.

### DETAILED DESCRIPTION

Some wireless communications systems may include passive devices, such as radio frequency identifier (RFID) tags and passive Internet-of-Things (IoT) devices. Passive devices may perform operations such as location tracking, identification, or other low-complexity tasks. Passive devices may include relatively low-complexity devices with limited resources and processing power. To communicate with a passive device, a querying device (e.g., a user equipment (UE), a network entity) may transmit a signal or query to the passive device to instruct the passive device to perform a writing operation and/or a reading operation. The passive device may, in some examples, employ energy harvesting by utilizing received signals to power or otherwise activate the passive device, and may transmit a backscattered signal to the querying device.

In some scenarios, a first wireless device (e.g., a UE, a network entity) may communicate with both a second wireless device and a passive device. Due to the reduced complexity of the passive device, however, the passive device may be restricted to relatively simpler communication schemes than the second wireless device. For example, the passive device may be unable to receive signals based on frequency selectivity and may utilize amplitude-based modulation schemes, such as on-off keying (OOK) modulation. Thus, the first wireless device may rely on time-domain multiplexing (TDM) techniques to communicate with the second wireless device and the passive device, which may be associated with relatively low spectral efficiency. For example, when the first wireless device transmits OOK modulation symbols to the passive device, the transmission may occupy the entirety of the associated frequency band. As such, the first wireless device may not be able to communicate with the second wireless device during transmissions to the passive device.

To improve communications efficiency, the first wireless device may combine a first transmission intended for the passive device and a second transmission intended for the second wireless device into a single signal. Here, the first wireless device may modulate the first transmission according to a first modulation scheme, such as OOK modulation, and may modulate the second transmission according to a second modulation scheme, such as 16 quadrature amplitude modulation (QAM). The first wireless device may generate and transmit a multiplexed waveform that includes the first transmission and the second transmission. In some cases, the first wireless device may transmit the multiplexed waveform via a set of subcarriers using orthogonal frequency division multiplexing (OFDM). The passive device and the second wireless device may receive the multiplexed waveform and may demodulate the multiplexed waveform to obtain the corresponding transmissions.

In some examples, however, the OOK modulation may reduce demodulation reliability at the second wireless device. For example, the second wireless device may be unaware that the multiplexed waveform includes the first transmission, and as such, may not expect the change in amplitude that occurs over OOK-modulated symbols of the first transmission. When the second wireless device implements amplitude-related demodulation schemes, such as 16QAM, this change in amplitude may introduce error in the demodulation procedure at the second wireless device.

Accordingly, aspects of the present disclosure are directed to signaling and other mechanisms used to support demodulation of multiplexed waveforms at a wireless device. Continuing the present example, the first wireless device may transmit, to the second wireless device, an indication of a set of modulation symbols of the first transmission (e.g., intended for the passive device). In some cases, the indication may represent a sequence of the set of modulation symbols, a transmit power for each modulation symbol of the set of modulation symbols, a relative modulation depth or relative transmit power for one or more modulation symbols of the set of modulation symbols, or a combination thereof. Additionally, or alternatively, the indication may be an example of one or more reference signals included with the multiplexed waveform. The second wireless device may utilize the indication to determine symbol energies of the multiplexed waveform, which may reduce the likelihood of demodulation errors or failures at the second wireless device.

Aspects of the disclosure are initially described in the context of wireless communications systems. Aspects of the disclosure are then discussed with reference to a multiplexed waveform configuration and slot configurations. Aspects of the disclosure are further illustrated by and described with reference to apparatus diagrams, system diagrams, and flowcharts that relate to techniques for communicating with passive devices using multiplexed waveforms.

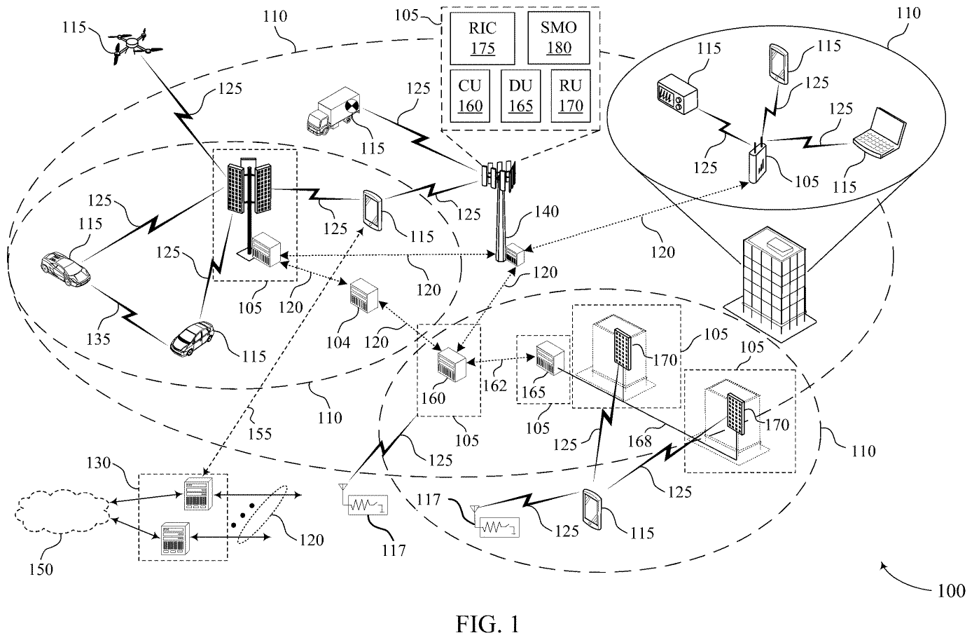

FIG. 1 illustrates an example of a wireless communications system 100 that supports techniques for communicating with passive devices using multiplexed waveforms in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for communicating with passive devices using multiplexed waveforms as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, or a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may include one or more passive devices 117. Passive devices 117 may rely on passive communication technologies, such as energy harvesting and backscatter communications, in order to operate using relatively low power and at relatively low cost. Passive devices 117 may include, but are not limited to, RFID tags, passive IoT devices, hybrid devices including passive and active components, passive components of otherwise active/querying devices (e.g., passive components of a UE 115), or any combination thereof. For example, in some cases, a UE 115 of the wireless communications system 100 may serve as a passive device 117. A network device (e.g., an NR device, such as a network entity 105 or a UE 115) communicating with a passive device 117 may be referred to as a reader device or a querying device.

Due to their low power and low complexity, the passive devices 117 may be limited to relatively small coverage areas. As such, some passive devices 117 may rely on distributed nodes of the wireless communications system 100, such as the UEs 115 or the network entities 105, to extend or enlarge coverage areas. Distributed nodes may provide a more powerful and flexible network for the passive devices 117 implementing backscatter communications. Moreover, a passive device 117 may harvest energy from ambient sources, such as radio frequency (RF) waves communicated between devices or nodes of the wireless communications system 100. Such implementations may be referred to as ambient backscatter or ambient power-enabled IoT.

A reader device associated with a passive device 117 may communicate with the passive device using communication parameters supported by the passive device 117. For example, the passive device 117 may be unable to receive signals based on frequency selectivity and may utilize amplitude-based modulation schemes, such as amplitude shift keying (ASK) or (OOK) modulation. To improve communications efficiency, the reader device may combine transmissions to both network devices and passive devices 117 in a single waveform by modulating respective transmissions based on the type of receiving device (e.g., network device or passive device) and multiplexing the transmissions via overlapping resources. As a specific example, the reader device may modulate a first transmission for a passive device 117 according to a first modulation scheme, such as OOK, and may modulate a second transmission for a network device according to a second modulation scheme, such as 16 QAM. The reader device may transmit the first transmission and the second transmission via a multiplexed waveform scheduled over at least partially overlapping resources. The network device and the passive device 117 may receive the multiplexed waveform and may demodulate the multiplexed waveform to obtain the corresponding transmissions.

The wireless communications system 100 may support signaling and other mechanisms to enable the network device to successfully demodulate and decode such multiplexed waveforms. In particular, the wireless communications system 100 may support signaling from the reader device that indicates information about modulation symbols of the first transmission (e.g., modulation symbols to be transmitted to the passive device 117 in the first transmission), which may assist the network device in demodulating the second transmission from the multiplexed waveform. For example, when the reader device is aware of the modulation symbols before transmitting the multiplexed waveform, the reader device may indicate, to the network device, a sequence corresponding to the modulation symbols. Additionally, or alternatively, the reader device may indicate, to the network device, amplitude or power information for the modulation symbols. In some implementations, the reader device may include reference signals in the multiplexed waveform for the network device to use to obtain the amplitude or power information. In other cases, such as when the reader device is unaware of the modulation symbols before transmitting the multiplexed waveform, the indication may include or be an example of a preemption indication associated with the multiplexed waveform. In such cases, the network device may flush or otherwise discard the modulation symbols associated with the first transmission.

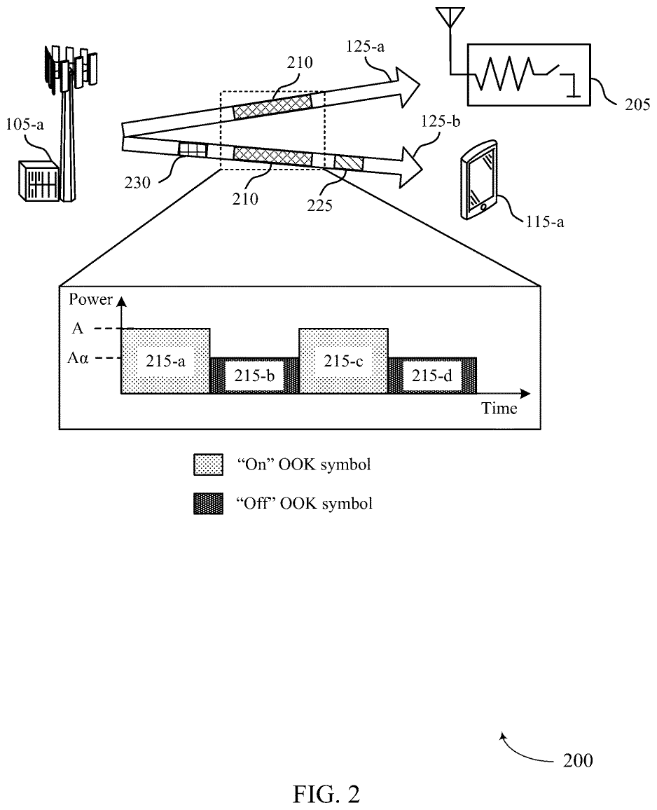

FIG. 2 illustrates an example of a wireless communications system 200 that supports techniques for communicating with passive devices using multiplexed waveforms in accordance with one or more aspects of the present disclosure. In some examples, aspects of the wireless communications system 200 may implement, or be implemented by, aspects of the wireless communications system 100. For example, the wireless communications system 200 may include a network entity 105-a and a UE 115-a, which may be examples of corresponding devices as described with reference to FIG. 1. The wireless communications system 200 may further include a passive device 205, which may include or be an example of a passive device as described herein.

In the wireless communications system 200, the network entity 105-a may be an example of (e.g., may operate as) a reader or querying device communicating with the passive device 205 and the UE 115-a via a multiplexed waveform 210. While FIG. 2 illustrates communications between a network entity 105-a and a UE 115-a, it is to be understood that other devices may implement or perform the techniques described herein, and the examples shown are not to be construed as limiting. For example, the UE 115-a may operate as a reader that communicates with the network entity 105-a and the passive device 205, and the network entity 105-a may receive the multiplexed waveform 210.

As it is used herein, the term “passive device” may be used to refer to devices which may utilize passive signaling for performance of transmissions by the passive device 205, actively powered radio signals for performance of transmissions by the passive device 205, or both. In this regard, the passive device 205 may receive power from radio frequency signals received from other devices (e.g., via energy harvesting), from power sources associated with the passive device 205, or both. Moreover, as it is used herein, the terms “querying device,” “reader,” “reader device,” “RF source,” or any combination thereof, may refer to wireless devices (e.g., UEs 115, network entities 105, IAB nodes) that are configured to communicate with a passive device 205, such as by transmitting signals (e.g., queries, commands) to the passive device 205 and/or receiving/reading signals from the passive device 205.

In some aspects, the passive device 205 (e.g., passive IoT devices) may include or be an example of a lower-complexity device (e.g., <100 μW device), such as an RFID tag, a passive IoT device, a hybrid device including passive and active components, or a passive component of a querying/active device (e.g., a passive component of a UE 115). For example, the passive device 205 may include a battery-less or a limited energy storage (e.g., capacitor) device capable of wireless communication, such as an RFID tag. The passive device 205 may be used to support various services and applications within the wireless communications system 200, such as identification or tracking. Other use cases that may be supported or facilitated by the passive device 205 may include power sourcing, security applications, access control or access connectivity management, and positioning services. Additionally, the passive device 205 may be capable of communicating over different frequency ranges, such as UHF ranges. For instance, the passive device 205 may include or be an example of a UHF RFID tag.

The passive device 205 of the wireless communications system 200 may be configured to perform various types of operations, including writing operations and reading operations. A writing operation may include one-way signaling from a querying device (e.g., the network entity 105-a) to a passive device 205 to configure or adjust parameters of the passive device 205. For example, writing operations may be used to change some information at a passive device 205 or adjust parameters or characteristics at a passive device 205, such as an identifier associated with the passive device 205 or a type or frequency of measurements performed by the passive device 205.

Comparatively, a reading operation may include two-way signaling between a querying device and a passive device 205 in which the querying device transmits a query or message, and receives or “reads” some responsive signaling back from the passive device 205. For example, in the context of a reading operation, the network entity 105-a may transmit a query to a passive device 205 to request some information from the passive device 205, and the passive device 205 may return information or data in response to the query, such as data, a type of control information, measurements performed by the passive device 205, a location of the passive device 205, sensed information, or any combination thereof.

As noted herein, in some implementations, the passive device 205 may include or be an example of a relatively low-complexity device which may or may not include a power amplifier and/or a battery. In some cases, the passive device 205 may include antennas (e.g., dipole antennas) and other circuitry (e.g., integrated circuit, chip, load) and components (e.g., rectifier, modulator, demodulator) used to facilitate wireless communications. In some aspects, the range over which the passive device 205 can transmit a message (e.g., a backscattered signal) may depend on the manner in which the passive device 205 is powered. For example, in some cases, the passive device 205 may not include a power source. Instead, the passive device 205 may support energy harvesting, in which the passive device 205 converts power absorbed from received signals or ambient sources. The passive device 205 may use the converted power to modulate and/or transmit a wave or message, for instance, as a response to a received command.

In some aspects, the passive device 205 may receive or generate power used for wireless communications and other operations using a rectifier, where a rectifier may include a diode and a capacitor. For example, the passive device 205 may receive a signal from a querying device via an antenna, where power absorbed from the antenna is directed to a power rectifier. The signal may be an example of a continuous wave (CW) or an NR signal. In this example, the power rectifier converts absorbed power from the antenna to rectified power, which may be directed back to the antenna to transmit messages (e.g., transmit backscattered signals).

Power absorbed via an antenna of the passive device 205 may be directed from the antenna through an ASK or phase-shift keying (PSK) modulator to the power rectifier. In order to perform signal modulation within the passive device 205, an ASK modulator may exhibit two different states. In a first state (e.g., matched load state), an integrated circuit or antenna resistance of the ASK modulator matches backscatter power (e.g., radiation power matches or equals power absorbed by the integrated circuit). Comparatively, in a second state (e.g., unmatched load state, or open circuit state), the integrated circuit or antenna resistance of the ASK modulator does not match the backscatter power. The modulation efficiency of an ASK modulator may be defined by Modulation Efficiency=Practical/Idealized Radiation Power.

In the example of FIG. 2, the network entity 105-a, the UE 115-a, and the passive device 205 may communicate with one another by exchanging unmodulated and modulated signals or waves (e.g., commands). The network entity 105-a and the UE 115-a may communicate via a communication link 125-b, which may include or be an example of an access link (e.g., a Uu link) that supports both uplink and downlink communication. The network entity 105-a may transmit a signal (e.g., a CW) to the passive device 205 via a communication link 125-a to power up the passive device 205, and may transmit (e.g., via the communication link 125-a) modulated commands or packets to instruct the passive device 205 to perform write operations, read operations, or both. As described herein, the terms “forward communication” and “backscatter communication” may refer to a relative direction of communication between a querying device (e.g., the network entity 105-a) and a passive device 205. For example, in the context of backscatter communication, the network entity 105-a, operating as a querying device, may transmit a signal or query to the passive device 205 via a forward link of the communication link 125-a, and the passive device 205 may transmit a backscattered message via a backscatter link of the communication link 125-a.

As discussed herein, the network entity 105-a may utilize a multiplexed waveform 210 to transmit communications to both the passive device 205 and the UE 115-a simultaneously. The multiplexed waveform may be generated (e.g., by the network entity 105-a) such that a first transmission for the passive device 205 is modulated according to a first modulation scheme and a second transmission for the UE 115-a is modulated according to a second modulation scheme, where the first transmission and the second transmission occupy resources (e.g., time resources, frequency resources) that at least partially overlap. The first modulation scheme may be an example of an amplitude-based modulation scheme, such as OOK or ASK, that is supported by the passive device 205. The second modulation scheme may be a modulation scheme that is supported by the UE 115-a, such as QAM (e.g., 16QAM, 256QAM, or any other order of QAM).

In some examples, the network entity 105-a may implement OFDM techniques to transmit the multiplexed waveform 210 via a set of orthogonal subcarriers. For instance, the network entity 105-a may modulate the second transmission according to QAM (e.g., the second modulation scheme) and may map the second transmission to the set of subcarriers using OFDM to obtain a set of OFDM symbols 215 (e.g., an OFDM symbol 215-a, an OFDM symbol 215-b, an OFDM symbol 215-c, an OFDM symbol 215-d). The network entity 105-a may modulate each OFDM symbol 215 of the first transmission using OOK (e.g., the first modulation scheme) to obtain the multiplexed waveform 210. Such techniques may be referred to as symbol-level OOK modulated OFDM or multi-carrier OOK. Each OFDM symbol 215 of the multiplexed waveform 210 may have a respective amplitude (e.g., transmit power) that represents, to the passive device 205, a bit value. For example, an OFDM symbol 215-a having first amplitude A may be understood as an “on” OOK symbol and may represent a bit value of 1, while an OFDM symbol 215-b having a second amplitude Aa may be understood as an “off” OOK symbol and may represent a bit value of 0. The second amplitude Aa may be scaled by a to be less than the first amplitude A, where 0≤α<1. This change in amplitude a between an “on” OOK symbol and an “off” OOK symbol may be referred to as a modulation depth or a transmit power reduction. The network entity 105-a may transmit the multiplexed waveform 210 to the passive device 205 and the UE 115-a. The passive device 205 may demodulate the multiplexed waveform 210 according to OOK to obtain the first transmission, while the UE 115-a may demodulate the multiplexed waveform according to QAM to obtain the second transmission.

In such examples, however, the reliability of demodulation of the multiplexed waveform 210 may be reduced as a result of the OOK amplitude modulation of the OFDM symbols 215. When the second modulation is an amplitude-based modulation scheme such as QAM, the UE 115-a may rely on an average symbol energy (also referred to as an average symbol power or average transmit power of the symbol) for each QAM symbol in each subcarrier of a respective OFDM symbol in order to correctly demodulate each QAM symbol. For example, the UE 115-a may utilize a reference signal, such as a demodulation reference signal (DMRS), to determine (e.g., measure or otherwise calculate) an average symbol energy for a given transmission associated with the reference signal. The UE 115-a may identify respective symbols of the transmission as corresponding to constellation points of an associated modulation constellation in accordance with the determined average symbol energy. For instance, the UE 115-a may apply a fast Fourier transform (FFT) to obtain a respective QAM symbol in each subcarrier of each OFDM symbol. The UE 115-a may demodulate the respective QAM symbols according to the corresponding average symbol energy.

In such examples, the average symbol energy may not change with each symbol. In contrast, when the symbols are further modulated according to OOK, the average symbol energy may vary on a per-symbol basis. That is, the changes in amplitude arising from OOK modulation may introduce error in the demodulation process at the UE 115-a. For example, when the UE 115-a does not expect the average symbol energy to vary by an amount a with each symbol, the UE 115-a may identify incorrect constellation points of the modulation constellation.

According to the techniques described herein, the network entity 105-a may provide the UE 115-a with information related to the first transmission and the first modulation scheme to enable the UE 115-a to correctly demodulate and decode the multiplexed waveform 210. In some cases, the network entity 105-a may be aware of the sequence of OOK symbols (e.g., the sequence of OFDM symbols 215 having varying amplitudes) to be included in the first transmission prior to transmitting the multiplexed waveform 210. In such cases, the network entity 105-a may transmit, to the UE 115-a, an indication 225 before transmitting the multiplexed waveform 210. The indication 225 may include or be an example of an indication of the sequence of OOK symbols, an indication of a transmit power or amplitude associated with each OOK symbol of the sequence of OOK symbols, an indication of the modulation depth or transmit power (e.g., the value of a), or some combination thereof. The UE 115-a may receive the multiplexed waveform 210 subsequent to receiving the indication 225. The UE 115-a may utilize the indication 225 to determine or otherwise identify a respective average symbol energy of each OFDM symbol 215 of the multiplexed waveform 210. Thus, the UE 115-a may demodulate QAM symbols from each OFDM symbol 215 in accordance with the corresponding average symbol energy.

In some cases, the network entity 105-a may transmit the indication 225 via a set of resources of a logical channel associated with indicating OOK symbol information. The indication 225 may be included as part of control signaling, such as downlink control information (DCI), a medium access control (MAC) control element (MAC-CE), or radio resource control (RRC) signaling. Further, the indication 225 may be transmitted on a per-UE basis or a per-cell basis. For example, if the second transmission includes information intended for a cell in which the UE 115-a is located, the indication 225 may be transmitted to the cell. Alternatively, the indication 225 may be transmitted to the UE 115-a alone. In some examples, the indication 225 may be transmitted in a same slot as the sequence of OOK symbols of the multiplexed waveform 210.

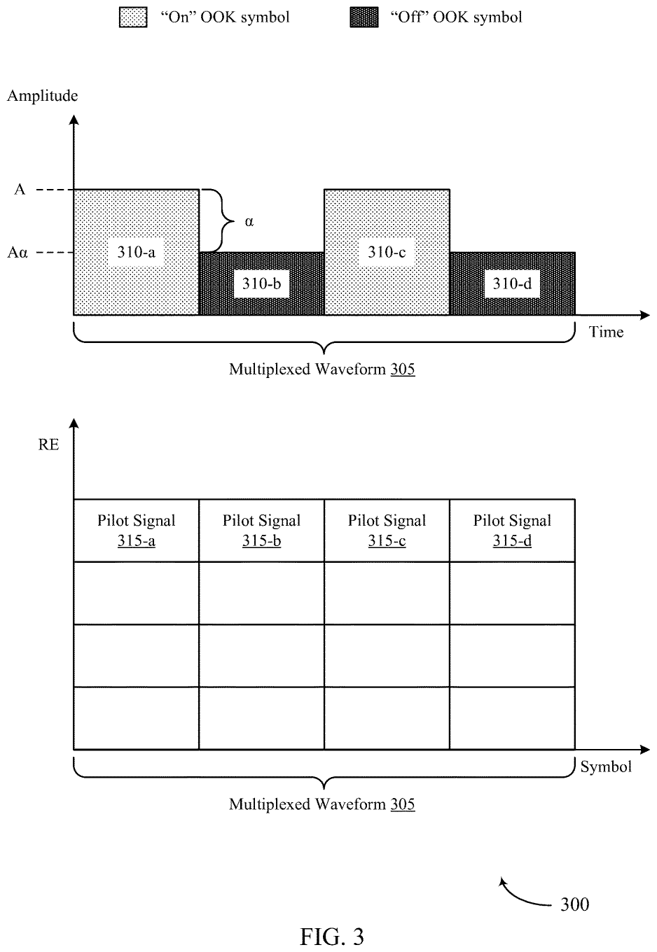

Additionally, or alternatively, the network entity 105-a may embed the information related to the first transmission and the first modulation scheme within the multiplexed waveform 210. For example, and as discussed in greater detail with reference to FIG. 3, the indication 225 may include one or more pilot signals corresponding to the OOK symbols. In some cases, the pilot signals may be examples of phase tracking reference signals (PT-RSs). A respective pilot signal may be located at an initial resource element (RE) of each OOK symbol. The UE 115-a may measure or otherwise determine the transmit power or average symbol energy of each pilot signal for use in demodulating the corresponding OFDM symbol 215. Thus, the UE 115-a may demodulate the second transmission based on the transmit power of the one or more pilot signals. In some cases, the network entity 105-a may additionally indicate, to the UE 115-a, the position of each pilot signal in the time domain and the frequency domain. For instance, the network entity 105-a may transmit DCI to the UE 115-a scheduling the pilot signals prior to transmitting the indication 225 (e.g., including the pilot signals) and the multiplexed waveform 210.

Alternatively, the network entity 105-a may not be aware of the sequence of OOK symbols prior to transmitting the multiplexed waveform 210, and may instead transmit an occupancy indication 230 (also referred to as a preemption indication) to the UE 115-a subsequent to transmitting the multiplexed waveform 210. The occupancy indication 230 may indicate, to the UE 115-a, that the multiplexed waveform 210 is occupied by the passive device 205 (e.g., includes information intended for the passive device 205). For example, the occupancy indication 230 may include or be an example of a DCI format associated with preemption indications, such as a DCI format 2_1. Based on the occupancy indication 230, the UE 115-a may flush or otherwise discard the multiplexed waveform 210. That is, although the UE 115-a may fail to demodulate and decode the multiplexed waveform 210, the UE 115-a may prevent further decoding error by refraining from including the multiplexed waveform 210 in retransmission and error correction procedures (e.g., soft combining).

In some cases, if the second transmission does not include control signaling (e.g., the second transmission is a data-only transmission), the network entity 105-a may implement a modulation scheme that is unrelated to amplitude as the second modulation scheme. For example, the second modulation scheme may be an example of phase-shift keying (PSK) modulation, such as quadrature phase-shift keying (QPSK), such that the UE 115-a does not utilize the amplitudes of the OFDM symbols 215 during demodulation. As such, demodulation of PSK symbols from the OFDM symbols 215 of the multiplexed waveform 210 at the UE 115-a may be unaffected by the varying amplitudes employed by OOK, and the network entity 105-a may refrain from transmitting the indication 225 or the occupancy indication 230. While such modulation schemes are limited to data-only transmissions and may be associated with relatively lower spectral efficiency, overhead associated with the multiplexed waveform 210 may be reduced.

In some implementations, a UE may instead operate as a reader that transmits the multiplexed waveform 210 to the passive device 205 and a network device, such as the UE 115-a or a network entity. In such cases, the UE may transmit the indication 225 via uplink control information (UCI) (e.g., when the network device is a network entity) or sidelink control information (SCI) (e.g., when the network device is a UE). Similarly, the UE may transmit the occupancy indication 230 via UCI (e.g., when the network device is a network entity) or SCI (e.g., when the network device is a UE). For example, the occupancy indication 230 may include or be an example of UCI having a UCI format associated with preemption indications. That is, the format of the UCI message may indicate that the multiplexed waveform 210 is occupied by the passive device 205. Based on the UCI, the network device may refrain from including the multiplexed waveform 210 in subsequent decoding operations.

FIG. 3 illustrates an example of a multiplexed waveform configuration 300 that supports techniques for communicating with passive devices using multiplexed waveforms in accordance with one or more aspects of the present disclosure. In some examples, aspects of the multiplexed waveform configuration 300 may implement, or be implemented by, aspects of the wireless communications system 100, the wireless communications system 200, or both. In particular, the multiplexed waveform configuration 300 illustrates signaling of a multiplexed waveform 305 transmitted by a reader to a passive device and a network device, which may be examples of corresponding devices as described herein. For example, the passive device may be an example of an RFID tag, while the reader and the network device may each be examples of a network entity 105 or a UE 115 as described with reference to FIGS. 1-2.

As described with reference to FIGS. 1-2, the multiplexed waveform 305 may be transmitted via OFDM and may include a first transmission for the passive device and a second transmission for the network device. The first transmission may be modulated (e.g., by the reader) according to a first modulation scheme and the second transmission may be modulated (e.g., by the reader) according to a second modulation scheme. In the example of FIG. 3, the first modulation scheme may be OOK and the second modulation scheme may be 16QAM, though the example shown is not to be construed as limiting and any other combination of modulation schemes may be used. Such techniques may be referred to as symbol-level OOK-modulated OFDM or multi-carrier OOK. The first transmission may thus include a first set of modulation symbols, referred to herein as OOK symbols, according to the first modulation scheme, and the second transmission may include a second set of modulation symbols, referred to herein as OFDM symbols 310, according to the second modulation scheme.

For example, the reader may modulate each OFDM symbol 310 of the multiplexed waveform 305 according to OOK. After OOK modulation, each OFDM symbol 310 may have a respective amplitude (e.g., transmit power) that represents a bit value of 1 or 0. As illustrated in FIG. 3, an OFDM symbol 310-a and an OFDM symbol 310-c each have a first amplitude A and may be understood as “on” OOK symbols that represent a bit value of 1. An OFDM symbol 310-b and an OFDM symbol 310-d may each have a second amplitude Aa and may be understood as “off” OOK symbols that represent a bit value of 0. The second amplitude Aa may be less than the first amplitude A based on an amount α, where 0≤α<1. This change in amplitude a between an “on” OOK symbol and an “off” OOK symbol may be referred to as a modulation depth or a transmit power reduction.

The first transmission may be scheduled to at least partially overlap with the second transmission, e.g., in the time domain, the frequency domain, or both. As such, the multiplexed waveform 305 may include at least a portion of the first transmission that is multiplexed with at least a portion of the second transmission. The reader may transmit the multiplexed waveform 305 to the passive device and the network device. The passive device may demodulate the first set of modulation symbols according to OOK to obtain the first transmission, while the network device may demodulate the second set of modulation symbols according to 16QAM to obtain the second transmission.

In some implementations, prior to transmitting the multiplexed waveform 305, the reader may transmit, to the network device, a message indicating information associated with the first set of modulation symbols. The network device receiving the message may utilize the information when demodulating the multiplexed waveform 305. In a first example, the message may indicate an OOK binary sequence that corresponds to the first set of modulation symbols. As illustrated in FIG. 3, the OOK binary sequence represented by the OFDM symbol 310-a, the OFDM symbol 310-b, the OFDM symbol 310-c, and the OFDM symbol 310-d may be [1,0,1,0]. Additionally, the message may indicate a relative modulation depth or a relative transmit power reduction for an “off” OOK symbol as compared to an “on” OOK symbol, where a transmit power of an “on” OOK symbol corresponds to an average symbol energy associated with the second modulation scheme. In some cases, the message may further indicate the transmit power of an “on” OOK symbol.

For example, the message may indicate that the relative transmit power reduction for the OFDM symbol 310-b compared to the OFDM symbol 310-a may be equal to a. During demodulation of the multiplexed waveform 305, the network device may determine, in accordance with the OOK binary sequence [1,0,1,0], that a first modulation symbol of the first set of modulation symbols corresponds to the OFDM symbol 310-a. Because the first modulation symbol represents the bit value of 1, the network device may assume that the amplitude (e.g., transmit power, average symbol energy) A of the OFDM symbol 310-a corresponds to an average symbol energy associated with the second modulation scheme. The network device may determine the amplitude A based on an associated reference signal, such as DMRS, received at the network device. Alternatively, in some cases, the message transmitted by the reader may further indicate the transmit power of the OFDM symbol 310-a corresponding to the amplitude A. The network device may calculate or otherwise determine the average symbol energy of the OFDM symbol 310-b using the amplitude (e.g., the average symbol energy) of the OFDM symbol 310-a and the relative transmit power reduction a. Thus, the network device may determine that “off” OOK symbols of the set of modulation symbols are associated with amplitudes (e.g., transmit powers, average symbol energies) of Aa. The network device may demodulate the remaining OFDM symbols 310-c and 310-d according to the OOK binary sequence and the corresponding amplitudes.

In a second example, the message may explicitly indicate a transmit power sequence corresponding to the first set of modulation symbols. For instance, the indication may include a respective transmit power (e.g., amplitude) for each modulation symbol of the first set of modulation symbols. In the example of FIG. 3, the message may indicate that the transmit power of the OFDM symbol 310-a is A, the transmit power of the OFDM symbol 310-b is A, the transmit power of the OFDM symbol 310-c is A, and the transmit power of the OFDM symbol 310-d is Aa. The network device may utilize the indicated transmit power sequence to demodulate the corresponding OFDM symbols 310.

In some cases, the reader may additionally or alternatively include one or more reference signals, such as pilot signals 315, with the first transmission and the second transmission in the multiplexed waveform 305, where the one or more pilot signals indicate the amplitude (e.g., transmit power) of corresponding OFDM symbols 310. The one or more pilot signals may be configured via a PHY layer, a MAC layer, or an RRC layer. The reader may transmit a pilot signal 315 at a fixed frequency position, such as an initial RE, in each OFDM symbol 310. The pilot signal 315 may correspond to a modulation symbol of an alphabet associated with the second modulation scheme, such that the network device receiving the pilot signal 315 may calculate or otherwise determine the transmit power of the corresponding OFDM symbol 310. For example, the reader may transmit, and the network device may receive, a pilot signal 315-a in an initial RE of the OFDM symbol 310-a, a pilot signal 315-b in an initial RE of the OFDM symbol 310-b, a pilot signal 315-c in an initial RE of the OFDM symbol 310-c, and a pilot signal 315-d in an initial RE of the OFDM symbol 310-d. The network device may determine the transmit power of the OFDM symbol 310-a based on receiving the pilot signal 315-a, may determine the transmit power of the OFDM symbol 310-b based on receiving the pilot signal 315-b, and so on, for each OFDM symbol 310. Using the transmit power of each OFDM symbol 310, the network device may correctly demodulate symbols in other REs of the respective OFDM symbol 310.

FIG. 3 illustrates a single pilot signal 315 for each OFDM symbol 310, such that a frequency density of the pilot signals 315 in the multiplexed waveform 305 is relatively low. However, based on channel conditions or other communication parameters, the reader may increase the frequency density of the pilot signals 315. For example, the network device may perform channel estimation based on channel measurements associated with communications with the reader. If the network device reports relatively poor channel conditions, the reader may transmit additional pilot signals 315 such that multiple pilot signals 315 are associated with each OFDM symbol 310, thereby improving the likelihood that the network device is able to determine the corresponding transmit powers and successfully demodulate the multiplexed waveform 305.

In some examples, the pilot signals 315 may be examples of PT-RSs. In general, a PT-RS may be associated with a time density that is a function of a scheduled MCS and a frequency density that is a function of a scheduled bandwidth. When implemented as pilot signals (e.g., pilot signals 315) in a multiplexed waveform configuration such as the multiplexed waveform configuration 300, the frequency density and the time density of PT-RSs may be relatively low. In particular, the frequency density may be reduced as compared to conventional PT-RS configurations. For example, the time density and the frequency density of PT-RSs as pilot signals 315 in the multiplexed waveform 305 may be set to minimum values, which may each be equal to 1.

In some implementations, the first modulation scheme may be an arbitrary-order ASK modulation scheme, such that each modulation symbol of the first set of modulation symbols has an amplitude level from a set of amplitude levels. In such cases, the reader may transmit, to the network device, a message indicating an ASK decimal sequence corresponding to the first set of modulation symbols, as well as a modulation depth or transmit power reduction of the transmit power at each amplitude level. For example, the message may indicate a respective transmit power reduction for each modulation symbol of a subset of modulation symbols of the first set of modulation symbols with respect to a first modulation symbol of the first set of modulation symbols. The first modulation symbol may correspond to the average symbol energy for the second modulation scheme. The network device may determine the average symbol energies for each modulation symbol of the subset of modulation symbols based on the transmit power reduction and the average symbol energy of the first modulation symbol, and may demodulate the multiplexed waveform 305 according to the average symbol energies and the ASK decimal sequence.

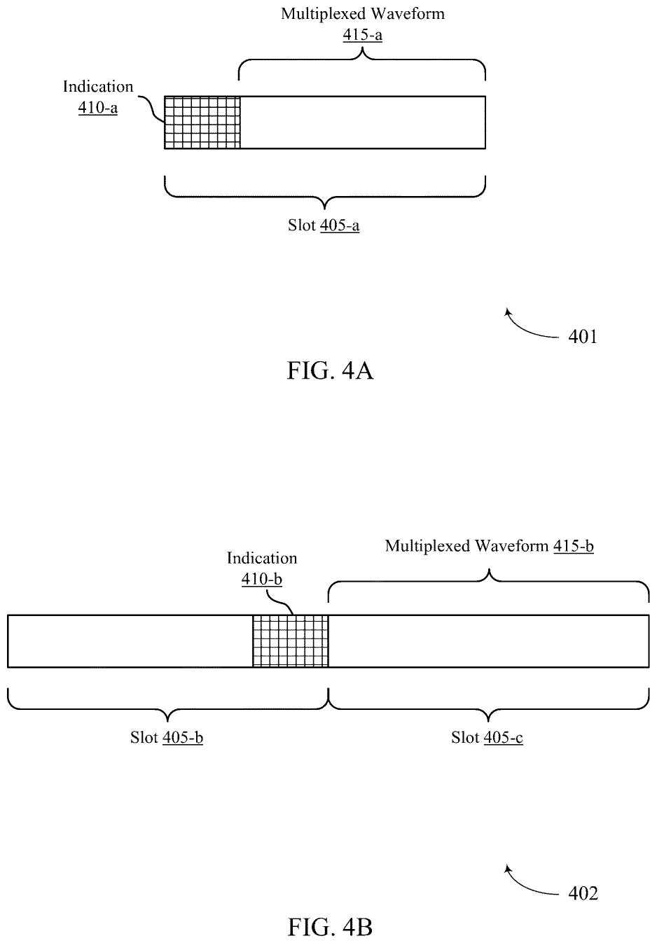

FIGS. 4A and 4B illustrate examples of slot configurations 401 and 402, respectively, that support techniques for communicating with passive devices using multiplexed waveforms in accordance with one or more aspects of the present disclosure. In some examples, aspects of the slot configurations 401 and 402 may implement, or be implemented by, aspects of the wireless communications system 100, the wireless communications system 200, or both. In particular, the slot configurations 401 and 402 illustrate signaling of a multiplexed waveform 415 transmitted in a slot 405 by a reader to a passive device and a network device. The reader, the network device, and the passive device may each be examples of corresponding devices described herein. The slot configurations 401 and 402 further illustrate an indication 410 transmitted via a logical channel associated with the multiplexed waveform 415.

As described with reference to FIGS. 1-3, the multiplexed waveform 415 may include a first transmission for the passive device and a second transmission for the network device. The first transmission may be modulated (e.g., by the reader) according to a first modulation scheme and the second transmission may be modulated (e.g., by the reader) according to a second modulation scheme. The first transmission may be scheduled to at least partially overlap with the second transmission, e.g., in the time domain, the frequency domain, or both. As such, the multiplexed waveform 415 may include at least a portion of the first transmission that is multiplexed with at least a portion of the second transmission. Additionally, as discussed with reference to FIG. 3, the reader may transmit, to the network device, an indication 410 of a set of modulation symbols of the first transmission. For example, the indication 410 may include a bit sequence (e.g., an OOK binary sequence, an ASK decimal sequence) corresponding to the set of modulation symbols, a relative modulation depth associated with the first modulation scheme, a relative transmit power for a first modulation symbol of the set of modulation symbols with respect to a second modulation symbol of the set of modulation symbols, a respective transmit power for each modulation symbol of the set of modulation symbols, or a combination thereof.

According to the techniques described herein, the reader may utilize a logical channel per slot 405 to transmit the indication 410. The logical channel may be associated with a set of resources (e.g., time resources, frequency resources, spatial resources) of a slot 405 that are dedicated to (e.g., associated with) indicating bit sequences (e.g., OOK binary sequences, ASK decimal sequences) for the set of modulation symbols. The logical channel may be located anywhere within the frequency domain of the slot 405, while the size of the logical channel in the frequency domain (e.g., a quantity of frequency resources of the set of resources) may be based on the set of modulation symbols. The reader may modulate the logical channel (e.g., the indication 410 transmitted via the logical channel) according to QPSK modulation.

In some cases, the indication 410 may include a quantity of bits that is based on a quantity of modulation symbols of the set of modulation symbols. For example, if the indication 410 includes a bit sequence corresponding to the set of modulation symbols, or an indication of a respective transmit power for each modulation symbol of the set of modulation symbols, the indication 410 may include a quantity of bits that is equal to the quantity of modulation symbols. In particular, when the first modulation scheme is OOK and the multiplexed waveform 415 is transmitted within a single slot 405, the indication 410 may include 14 bits. That is, the slot 405 may include 14 OFDM symbols, where one OFDM symbol corresponds to one OOK symbol, and one respective bit is used to indicate each OOK symbol. Accordingly, the set of resources of the logical channel may include a quantity of resources (e.g., REs) in the frequency domain of the slot 405 that is based on the quantity of modulation symbols. Continuing the present example, for a QPSK-modulated logical channel, the set of resources may include at least seven REs to indicate a 14-bit indication 410 (e.g., based on the QPSK symbol rate of two bits per symbol). If the reader encodes the indication 410, the set of resources may include additional REs (e.g., based on a coding rate).

The set of resources of the logical channel may further include one or more time-domain resources of a slot 405 such that, in some cases, the logical channel may occupy time-domain resources in a same slot 405 in which the multiplexed waveform 415 is transmitted. For example, FIG. 4A illustrates a slot configuration 401 in which a multiplexed waveform 415-a and an indication 410-a are transmitted by the reader within a same slot 405-a. The reader may transmit the indication 410-a via the set of resources of the logical channel. The set of resources of the logical channel may be located such that the indication 410-a is transmitted prior to transmission of the multiplexed waveform 415-a. That is, the set of resources may include an initial time-domain resource of the slot 405-a. The network device may receive the indication 410-a via the logical channel and may utilize the indication 410-a to demodulate the multiplexed waveform 415-a.

Alternatively, the set of resources of the logical channel may include a final time-domain resource of a slot that occurs prior to a slot in which the multiplexed waveform 415 is transmitted. As illustrated in FIG. 4B, for example, the reader may transmit an indication 410-b via a logical channel of a slot 405-b, where the indication 410-b indicates the set of modulation symbols for a slot 405-c subsequent to the slot 405-b. That is, the slot 405-b may occur prior to a slot 405-c in which the reader may transmit a multiplexed waveform 415-b. The network device may demodulate the multiplexed waveform 415-b in the slot 405-c based on receiving the indication 410-b via the logical channel of the slot 405-b.

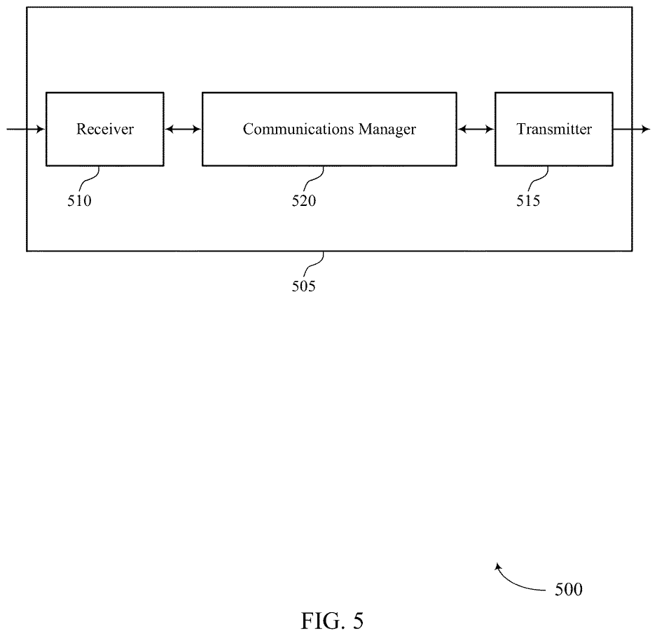

FIG. 5 illustrates a block diagram 500 of a device 505 that supports techniques for communicating with passive devices using multiplexed waveforms in accordance with one or more aspects of the present disclosure. The device 505 may be an example of aspects of a UE 115 or a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for communicating with passive devices using multiplexed waveforms). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for communicating with passive devices using multiplexed waveforms). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for communicating with passive devices using multiplexed waveforms as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first wireless device in accordance with examples as disclosed herein. For example, the communications manager 520 may be configured as or otherwise support a means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme. The communications manager 520 may be configured as or otherwise support a means for transmitting, in accordance with the indication, a multiplexed waveform including the first transmission according to the first modulation scheme multiplexed with at least a portion of the second transmission according to the second modulation scheme.

Additionally, or alternatively, the communications manager 520 may support wireless communications at a second wireless device in accordance with examples as disclosed herein. For example, the communications manager 520 may be configured as or otherwise support a means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme. The communications manager 520 may be configured as or otherwise support a means for receiving, in accordance with the indication, a multiplexed waveform including the first transmission according to the first modulation scheme multiplexed with at least a portion of the second transmission according to the second modulation scheme.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for indicating and receiving information about passive device multiplexed waveforms. As such, the techniques described herein may enable the device 505 to successfully receive and demodulate transmissions that are multiplexed with transmissions to passive devices. Further, reducing demodulation and decoding failures at the device 505 may reduce processing and improve communications efficiency.

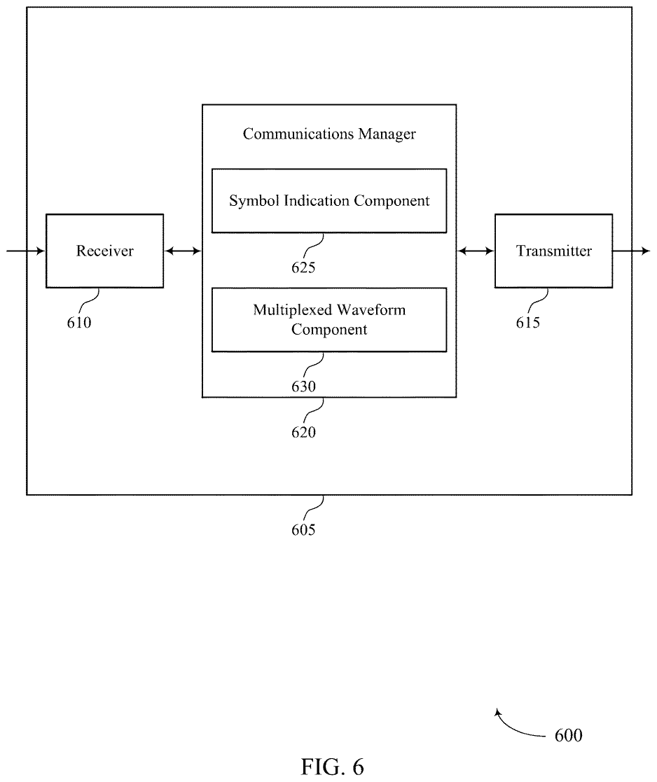

FIG. 6 illustrates a block diagram 600 of a device 605 that supports techniques for communicating with passive devices using multiplexed waveforms in accordance with one or more aspects of the present disclosure. The device 605 may be an example of aspects of a device 505, a UE 115, or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for communicating with passive devices using multiplexed waveforms). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for communicating with passive devices using multiplexed waveforms). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for communicating with passive devices using multiplexed waveforms as described herein. For example, the communications manager 620 may include a symbol indication component 625, a multiplexed waveform component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first wireless device in accordance with examples as disclosed herein. The symbol indication component 625 may be configured as or otherwise support a means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme. The multiplexed waveform component 630 may be configured as or otherwise support a means for transmitting, in accordance with the indication, a multiplexed waveform including the first transmission according to the first modulation scheme multiplexed with at least a portion of the second transmission according to the second modulation scheme.

Additionally, or alternatively, the communications manager 620 may support wireless communications at a second wireless device in accordance with examples as disclosed herein. The symbol indication component 625 may be configured as or otherwise support a means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme. The multiplexed waveform component 630 may be configured as or otherwise support a means for receiving, in accordance with the indication, a multiplexed waveform including the first transmission according to the first modulation scheme multiplexed with at least a portion of the second transmission according to the second modulation scheme.

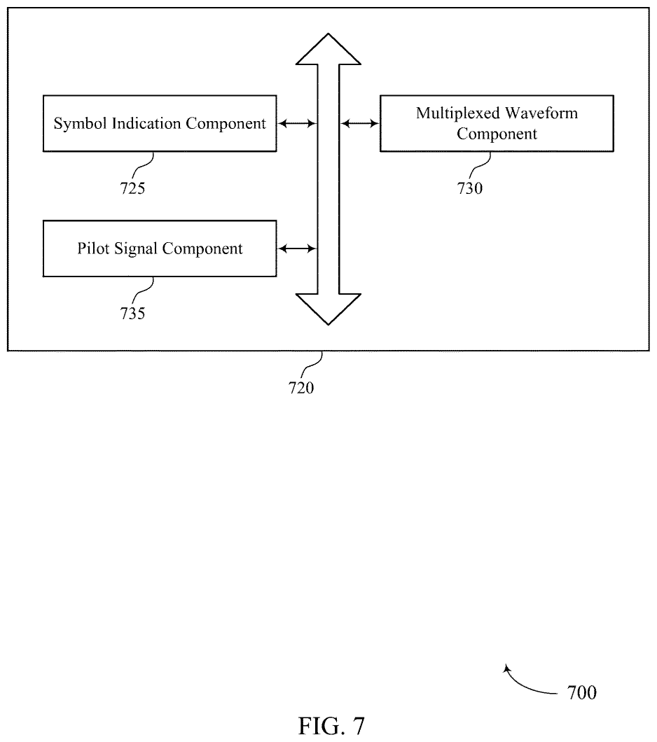

FIG. 7 illustrates a block diagram 700 of a communications manager 720 that supports techniques for communicating with passive devices using multiplexed waveforms in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for communicating with passive devices using multiplexed waveforms as described herein. For example, the communications manager 720 may include a symbol indication component 725, a multiplexed waveform component 730, a pilot signal component 735, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications at a first wireless device in accordance with examples as disclosed herein. The symbol indication component 725 may be configured as or otherwise support a means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme. The multiplexed waveform component 730 may be configured as or otherwise support a means for transmitting, in accordance with the indication, a multiplexed waveform including the first transmission according to the first modulation scheme multiplexed with at least a portion of the second transmission according to the second modulation scheme.

In some examples, the indication is transmitted prior to transmitting the multiplexed waveform.

In some examples, the first modulation scheme includes an OOK modulation scheme. In some examples, the indication includes an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.

In some examples, the first modulation scheme includes an OOK modulation scheme. In some examples, the indication includes a respective transmit power for each modulation symbol of the set of modulation symbols.

In some examples, the first modulation scheme includes an ASK modulation scheme. In some examples, the indication includes an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

In some examples, the indication includes one or more pilot signals associated with one or more modulation symbols of the set of modulation symbols. In some examples, the pilot signal component 735 may be configured as or otherwise support a means for transmitting an indication of one or more time domain resources and one or more frequency domain resources for each of the one or more pilot signals, where the indication of the one or more time domain resources and one or more frequency domain resources is transmitted prior to transmitting the indication of the set of modulation symbols in the first transmission.

In some examples, the one or more pilot signals include one or more PT-RSs. In some examples, the indication is transmitted via a set of resources of a logical channel associated with indicating an OOK binary sequence for the set of modulation symbols. In some examples, the set of resources includes a quantity of frequency domain resources that is based on a quantity of symbols of the set of modulation symbols.

In some examples, the multiplexed waveform is within a slot. In some examples, the set of resources of the indication includes an initial time domain resource of the slot. In some examples, the multiplexed waveform is within a first slot. In some examples, the set of resources of the indication includes a final time domain resource of a second slot prior to the first slot.

In some examples, to support transmitting the indication, the symbol indication component 725 may be configured as or otherwise support a means for transmitting DCI having a format associated with a preemption indication. In some examples, to support transmitting the indication, the symbol indication component 725 may be configured as or otherwise support a means for transmitting UCI having a format associated with a preemption indication.

In some examples, the third wireless device is a passive device and the first wireless device is a reader node associated with reading the passive device.

Additionally, or alternatively, the communications manager 720 may support wireless communications at a second wireless device in accordance with examples as disclosed herein. The symbol indication component 725 may be configured as or otherwise support a means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme. The multiplexed waveform component 730 may be configured as or otherwise support a means for receiving, in accordance with the indication, a multiplexed waveform including the first transmission according to the first modulation scheme multiplexed with at least a portion of the second transmission according to the second modulation scheme.

In some examples, the indication is received prior to receiving the multiplexed waveform.

In some examples, the first modulation scheme includes an OOK modulation scheme. In some examples, the indication includes an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.

In some examples, the first modulation scheme includes an OOK modulation scheme. In some examples, the indication includes a respective transmit power for each modulation symbol of the set of modulation symbols.

In some examples, the first modulation scheme includes an ASK modulation scheme. In some examples, the indication includes an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

In some examples, the indication includes one or more pilot signals associated with one or more modulation symbols of the set of modulation symbols. In some examples, the pilot signal component 735 may be configured as or otherwise support a means for receiving an indication of one or more time domain resources and one or more frequency domain resources for each of the one or more pilot signals, where the indication of the one or more time domain resources and one or more frequency domain resources is received prior to receiving the indication of the set of modulation symbols in the first transmission.

In some examples, the pilot signal component 735 may be configured as or otherwise support a means for determining a transmit power of the one or more pilot signals. In some examples, the multiplexed waveform component 730 may be configured as or otherwise support a means for demodulating the second transmission according to the second modulation scheme based on the transmit power. In some examples, the one or more pilot signals include one or more PT-RSs.

In some examples, the indication is received via a set of resources of a logical channel associated with indicating an OOK binary sequence for the set of modulation symbols. In some examples, the set of resources includes a quantity of frequency domain resources that is based on a quantity of modulation symbols of the set of modulation symbols.

In some examples, the multiplexed waveform is within a slot. In some examples, the set of resources of the indication includes an initial time domain resource of the slot. In some examples, the multiplexed waveform is within a first slot. In some examples, the set of resources of the indication includes a final time domain resource of a second slot prior to the first slot.

In some examples, to support receiving the indication, the symbol indication component 725 may be configured as or otherwise support a means for receiving DCI having a format associated with a preemption indication. In some examples, to support receiving the indication, the symbol indication component 725 may be configured as or otherwise support a means for receiving UCI having a format associated with a preemption indication.

In some examples, the third wireless device is a passive device and the first wireless device is a reader node associated with reading the passive device.

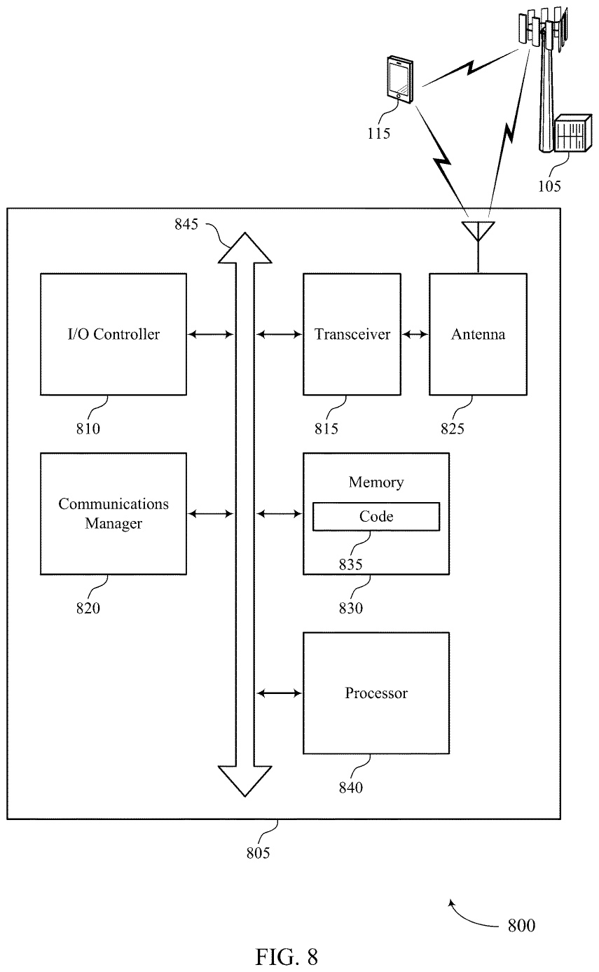

FIG. 8 illustrates a diagram of a system 800 including a device 805 that supports techniques for communicating with passive devices using multiplexed waveforms in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROIDR, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for communicating with passive devices using multiplexed waveforms). For example, the device 805 or a component of the device 805 may include a processor 840 and memory 830 coupled with or to the processor 840, the processor 840 and memory 830 configured to perform various functions described herein.

The communications manager 820 may support wireless communications at a first wireless device in accordance with examples as disclosed herein. For example, the communications manager 820 may be configured as or otherwise support a means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme. The communications manager 820 may be configured as or otherwise support a means for transmitting, in accordance with the indication, a multiplexed waveform including the first transmission according to the first modulation scheme multiplexed with at least a portion of the second transmission according to the second modulation scheme.

Additionally, or alternatively, the communications manager 820 may support wireless communications at a second wireless device in accordance with examples as disclosed herein. For example, the communications manager 820 may be configured as or otherwise support a means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme. The communications manager 820 may be configured as or otherwise support a means for receiving, in accordance with the indication, a multiplexed waveform including the first transmission according to the first modulation scheme multiplexed with at least a portion of the second transmission according to the second modulation scheme.

By including or configuring the communications manager 820 in accordance with examples as described herein, the device 805 may support techniques for indicating and receiving information about passive device multiplexed waveforms. As such, the techniques described herein may enable the device 805 to successfully receive and demodulate transmissions that are multiplexed with transmissions to passive devices. Further, reducing demodulation and decoding failures at the device 805 may reduce latency and improve communications reliability and efficiency.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 (e.g., directly, indirectly, after pre-processing, without pre-processing) to cause the device 805 to perform various aspects of techniques for communicating with passive devices using multiplexed waveforms as described herein, or the processor 840 and the memory 830 may be otherwise configured to perform or support such operations.

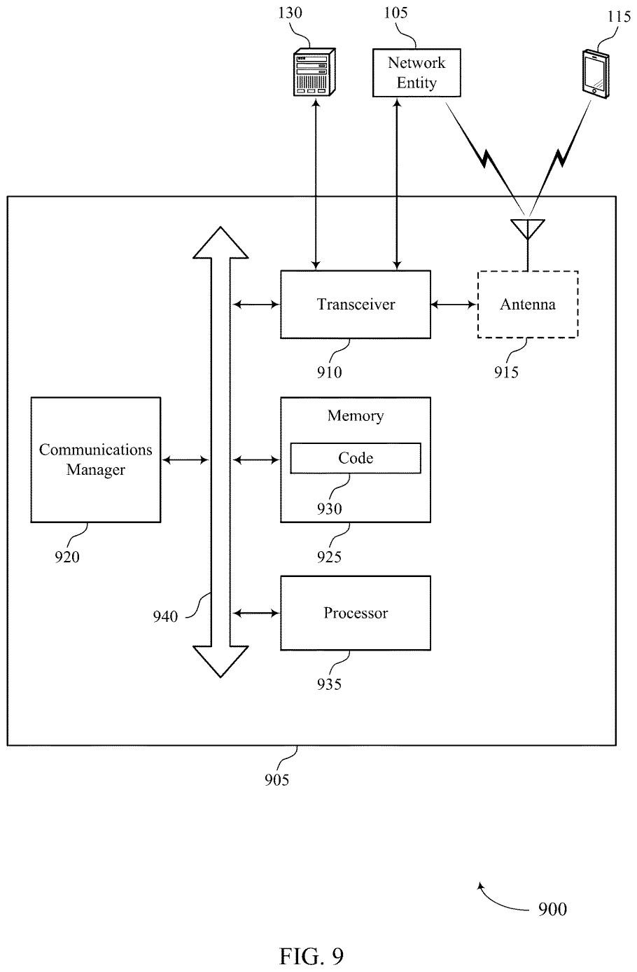

FIG. 9 illustrates a diagram of a system 900 including a device 905 that supports techniques for communicating with passive devices using multiplexed waveforms in accordance with one or more aspects of the present disclosure. The device 905 may be an example of or include the components of a device 505, a device 605, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting techniques for communicating with passive devices using multiplexed waveforms). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system.

A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a first wireless device in accordance with examples as disclosed herein. For example, the communications manager 920 may be configured as or otherwise support a means for transmitting, to a second wireless device, an indication of a set of modulation symbols in a first transmission to a third wireless device using a first modulation scheme, where the first transmission is scheduled to at least partially overlap with a second transmission to the second wireless device using a second modulation scheme. The communications manager 920 may be configured as or otherwise support a means for transmitting, in accordance with the indication, a multiplexed waveform including the first transmission according to the first modulation scheme multiplexed with at least a portion of the second transmission according to the second modulation scheme.

Additionally, or alternatively, the communications manager 920 may support wireless communications at a second wireless device in accordance with examples as disclosed herein. For example, the communications manager 920 may be configured as or otherwise support a means for receiving, from a first wireless device, an indication of a set of modulation symbols in a first transmission to a third wireless device using a first modulation scheme, where the first transmission is scheduled to at least partially overlap with a second transmission to the second wireless device using a second modulation scheme. The communications manager 920 may be configured as or otherwise support a means for receiving, in accordance with the indication, a multiplexed waveform including the first transmission according to the first modulation scheme multiplexed with at least a portion of the second transmission according to the second modulation scheme.

By including or configuring the communications manager 920 in accordance with examples as described herein, the device 905 may support techniques for indicating and receiving information about passive device multiplexed waveforms. For example, the techniques described herein may enable the device 905 to simultaneously communicate with other network devices and passive devices, which may reduce utilization of communications resources and improve system efficiency. Further, by providing information about the multiplexed waveform to receiving network devices, the device 905 may assist the receiving network devices in demodulating the multiplexed waveform, thereby reducing latency and improving communications reliability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 (e.g., directly, indirectly, after pre-processing, without pre-processing) to cause the device 905 to perform various aspects of techniques for communicating with passive devices using multiplexed waveforms as described herein, or the processor 935 and the memory 925 may be otherwise configured to perform or support such operations.

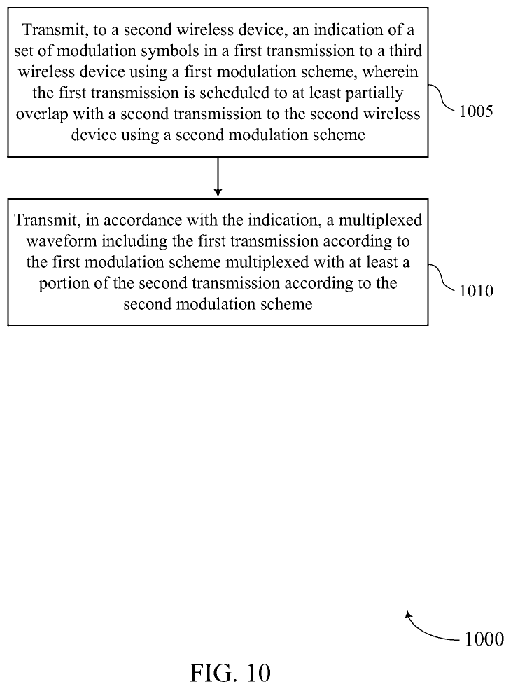

FIG. 10 illustrates a flowchart showing a method 1000 that supports techniques for communicating with passive devices using multiplexed waveforms in accordance with one or more aspects of the present disclosure. The operations of the method 1000 may be implemented by a UE or a network entity or its components as described herein. For example, the operations of the method 1000 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include transmitting, to a second wireless device, an indication of a set of modulation symbols in a first transmission to a third wireless device using a first modulation scheme, wherein the first transmission is scheduled to at least partially overlap with a second transmission to the second wireless device using a second modulation scheme. The operations of 1005 may be performed in accordance with examples as disclosed herein. In some examples, aspects of the operations of 1005 may be performed by a symbol indication component 725 as described with reference to FIG. 7.

At 1010, the method may include transmitting, in accordance with the indication, a multiplexed waveform including the first transmission according to the first modulation scheme multiplexed with at least a portion of the second transmission according to the second modulation scheme. The operations of 1010 may be performed in accordance with examples as disclosed herein. In some examples, aspects of the operations of 1010 may be performed by a multiplexed waveform component 730 as described with reference to FIG. 7.

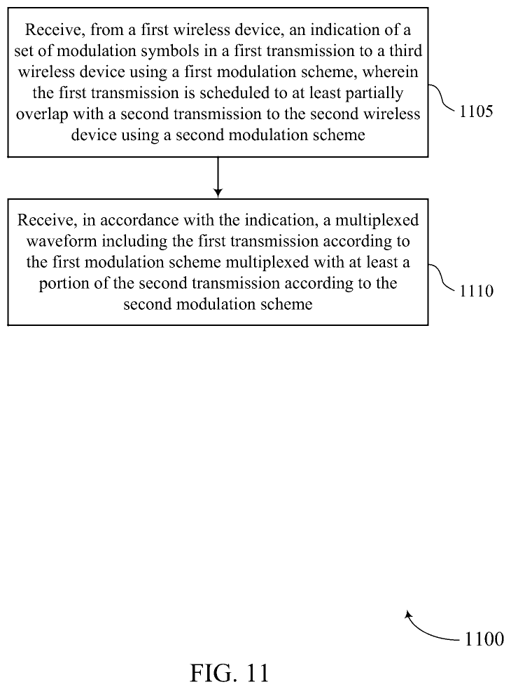

FIG. 11 illustrates a flowchart showing a method 1100 that supports techniques for communicating with passive devices using multiplexed waveforms in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include receiving, from a first wireless device, an indication of a set of modulation symbols in a first transmission to a third wireless device using a first modulation scheme, wherein the first transmission is scheduled to at least partially overlap with a second transmission to the second wireless device using a second modulation scheme. The operations of 1105 may be performed in accordance with examples as disclosed herein. In some examples, aspects of the operations of 1105 may be performed by a symbol indication component 725 as described with reference to FIG. 7.

At 1110, the method may include receiving, in accordance with the indication, a multiplexed waveform including the first transmission according to the first modulation scheme multiplexed with at least a portion of the second transmission according to the second modulation scheme. The operations of 1110 may be performed in accordance with examples as disclosed herein. In some examples, aspects of the operations of 1110 may be performed by a multiplexed waveform component 730 as described with reference to FIG. 7.

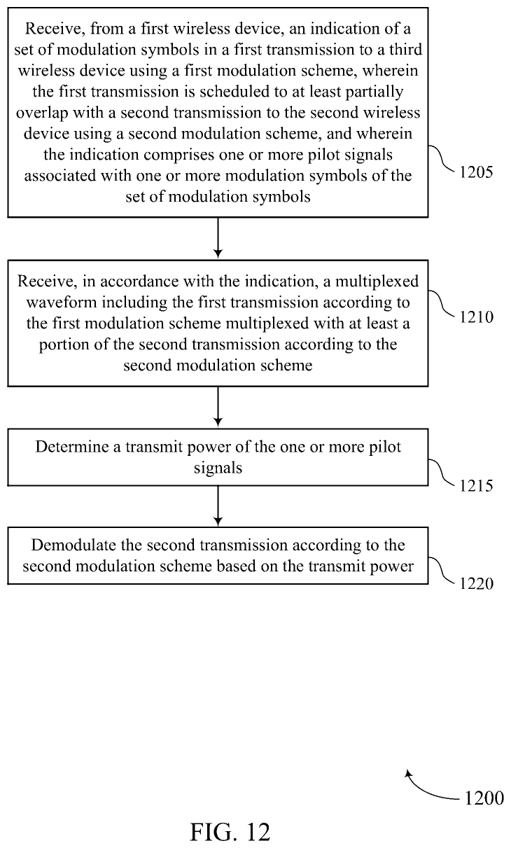

FIG. 12 illustrates a flowchart showing a method 1200 that supports techniques for communicating with passive devices using multiplexed waveforms in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving, from a first wireless device, an indication of a set of modulation symbols in a first transmission to a third wireless device using a first modulation scheme, wherein the first transmission is scheduled to at least partially overlap with a second transmission to the second wireless device using a second modulation scheme, and wherein the indication comprises one or more pilot signals associated with one or more modulation symbols of the set of modulation symbols. The operations of 1205 may be performed in accordance with examples as disclosed herein. In some examples, aspects of the operations of 1205 may be performed by a symbol indication component 725 as described with reference to FIG. 7.

At 1210, the method may include receiving, in accordance with the indication, a multiplexed waveform including the first transmission according to the first modulation scheme multiplexed with at least a portion of the second transmission according to the second modulation scheme. The operations of 1210 may be performed in accordance with examples as disclosed herein. In some examples, aspects of the operations of 1210 may be performed by a multiplexed waveform component 730 as described with reference to FIG. 7.

At 1215, the method may include determining a transmit power of the one or more pilot signals. The operations of 1215 may be performed in accordance with examples as disclosed herein. In some examples, aspects of the operations of 1215 may be performed by a pilot signal component 735 as described with reference to FIG. 7.

At 1220, the method may include demodulating the second transmission according to the second modulation scheme based at least in part on the transmit power. The operations of 1220 may be performed in accordance with examples as disclosed herein. In some examples, aspects of the operations of 1220 may be performed by a multiplexed waveform component 730 as described with reference to FIG. 7.

The following provides an overview of aspects of the present disclosure:
Aspect 1: A method for wireless communications at a first wireless device, comprising: transmitting, to a second wireless device, an indication of a set of modulation symbols in a first transmission to a third wireless device using a first modulation scheme, wherein the first transmission is scheduled to at least partially overlap with a second transmission to the second wireless device using a second modulation scheme; and transmitting, in accordance with the indication, a multiplexed waveform comprising the first transmission according to the first modulation scheme multiplexed with at least a portion of the second transmission according to the second modulation scheme.
Aspect 2: The method of aspect 1, wherein the indication is transmitted prior to transmitting the multiplexed waveform.
Aspect 3: The method of aspect 2, wherein the first modulation scheme comprises an OOK modulation scheme; and the indication comprises an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.
Aspect 4: The method of aspect 2, wherein the first modulation scheme comprises an OOK modulation scheme; and the indication comprises a respective transmit power for each modulation symbol of the set of modulation symbols.
Aspect 5: The method of aspect 1, wherein the first modulation scheme comprises an ASK modulation scheme; and the indication comprises an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.
Aspect 6: The method of aspect 1, wherein the indication comprises one or more pilot signals associated with one or more modulation symbols of the set of modulation symbols.
Aspect 7: The method of aspect 6, further comprising: transmitting an indication of one or more time domain resources and one or more frequency domain resources for each of the one or more pilot signals, wherein the indication of the one or more time domain resources and one or more frequency domain resources is transmitted prior to transmitting the indication of the set of modulation symbols in the first transmission.
Aspect 8: The method of any of aspects 6 through 7, wherein the one or more pilot signals comprise one or more PT-RSs.
Aspect 9: The method of any of aspects 1 through 8, wherein the indication is transmitted via a set of resources of a logical channel associated with indicating an OOK binary sequence for the set of modulation symbols; and the set of resources includes a quantity of frequency domain resources that is based at least in part on a quantity of symbols of the set of modulation symbols.
Aspect 10: The method of aspect 9, wherein the multiplexed waveform is within a slot; and the set of resources of the indication includes an initial time domain resource of the slot.
Aspect 11: The method of aspect 9, wherein the multiplexed waveform is within a first slot; and the set of resources of the indication includes a final time domain resource of a second slot prior to the first slot.
Aspect 12: The method of any of aspects 1 through 11, wherein the first wireless device is a network node, and wherein transmitting the indication comprises: transmitting DCI having a format associated with a preemption indication.
Aspect 13: The method of any of aspects 1 through 11, wherein the first wireless device is a UE, and wherein transmitting the indication comprises: transmitting UCI having a format associated with a preemption indication.
Aspect 14: The method of any of aspects 1 through 13, wherein the third wireless device is a passive device and the first wireless device is a reader node associated with reading the passive device.
Aspect 15: A method for wireless communications at a second wireless device, comprising: receiving, from a first wireless device, an indication of a set of modulation symbols in a first transmission to a third wireless device using a first modulation scheme, wherein the first transmission is scheduled to at least partially overlap with a second transmission to the second wireless device using a second modulation scheme; and receiving, in accordance with the indication, a multiplexed waveform comprising the first transmission according to the first modulation scheme multiplexed with at least a portion of the second transmission according to the second modulation scheme.
Aspect 16: The method of aspect 15, wherein the indication is received prior to receiving the multiplexed waveform.
Aspect 17: The method of aspect 16, wherein the first modulation scheme comprises an OOK modulation scheme; and the indication comprises an OOK binary sequence corresponding to the set of modulation symbols, a relative modulation depth of associated with the OOK modulation scheme, a relative transmit power for a first modulation symbol of the set of modulation symbols with respect to a second modulation symbol of the set of modulation symbols, or a combination thereof.
Aspect 18: The method of aspect 16, wherein the first modulation scheme comprises an OOK modulation scheme; and the indication comprises a respective transmit power for each modulation symbol of the set of modulation symbols.
Aspect 19: The method of aspect 15, wherein the first modulation scheme comprises an ASK modulation scheme; and the indication comprises an ASK decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.
Aspect 20: The method of aspect 15, wherein the indication comprises one or more pilot signals associated with one or more modulation symbols of the set of modulation symbols.
Aspect 21: The method of aspect 20, further comprising: receiving an indication of one or more time domain resources and one or more frequency domain resources for each of the one or more pilot signals, wherein the indication of the one or more time domain resources and one or more frequency domain resources is received prior to receiving the indication of the set of modulation symbols in the first transmission.
Aspect 22: The method of any of aspects 20 through 21, further comprising: determining a transmit power of the one or more pilot signals; and demodulating the second transmission according to the second modulation scheme based at least in part on the transmit power.
Aspect 23: The method of any of aspects 20 through 22, wherein the one or more pilot signals comprise one or more PT-RSs.
Aspect 24: The method of any of aspects 15 through 23, wherein the indication is received via a set of resources of a logical channel associated with indicating an OOK binary sequence for the set of modulation symbols; and the set of resources includes a quantity of frequency domain resources that is based at least in part on a quantity of modulation symbols of the set of modulation symbols.
Aspect 25: The method of aspect 24, wherein the multiplexed waveform is within a slot; and the set of resources of the indication includes an initial time domain resource of the slot.
Aspect 26: The method of aspect 24, wherein the multiplexed waveform is within a first slot; and the set of resources of the indication includes a final time domain resource of a second slot prior to the first slot.
Aspect 27: The method of any of aspects 15 through 26, wherein the first wireless device is a network node, and wherein receiving the indication comprises: receiving DCI having a format associated with a preemption indication.
Aspect 28: The method of any of aspects 15 through 26, wherein the first wireless device is a UE, and wherein receiving the indication comprises: receiving UCI having a format associated with a preemption indication.
Aspect 29: The method of any of aspects 15 through 28, wherein the third wireless device is a passive device and the first wireless device is a reader node associated with reading the passive device.
Aspect 30: An apparatus for wireless communications at a first wireless device, comprising at least one processor; and memory coupled with the at least one processor, the memory storing instructions executable by the processor to cause the first wireless device to perform a method of any of aspects 1 through 14.
Aspect 31: An apparatus for wireless communications at a first wireless device, comprising at least one means for performing a method of any of aspects 1 through 14.
Aspect 32: A non-transitory computer-readable medium storing code for wireless communications at a first wireless device, the code comprising instructions executable by at least one processor to perform a method of any of aspects 1 through 14.
Aspect 33: An apparatus for wireless communications at a second wireless device, comprising at least one processor; and memory coupled with the at least one processor, the memory storing instructions executable by the processor to cause the first wireless device to perform a method of any of aspects 15 through 29.
Aspect 34: An apparatus for wireless communications at a second wireless device, comprising at least one means for performing a method of any of aspects 15 through 29.
Aspect 35: A non-transitory computer-readable medium storing code for wireless communications at a second wireless device, the code comprising instructions executable by a processor to cause the second wireless device to perform a method of any of aspects 15 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), and ascertaining. Also, “determining” or “identifying” can include receiving (such as receiving information or signaling, e.g., receiving information or signaling for determining, receiving information or signaling for identifying), and accessing (such as accessing data in a memory, or accessing information). Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first wireless device, comprising:
at least one processor; and
memory coupled with the at least one processor, the memory storing instructions executable by the at least one processor to cause the first wireless device to:
transmit, to a second wireless device, an indication of a set of modulation symbols in a first transmission to a third wireless device using a first modulation scheme, wherein the first transmission is scheduled to at least partially overlap with a second transmission to the second wireless device using a second modulation scheme; and
transmit, in accordance with the indication, a multiplexed waveform comprising the first transmission according to the first modulation scheme multiplexed with at least a portion of the second transmission according to the second modulation scheme.

2. The apparatus of claim 1, wherein the indication is transmitted prior to transmitting the multiplexed waveform.

3. The apparatus of claim 2, wherein:
the first modulation scheme comprises an on-off keying modulation scheme; and
the indication comprises an on-off keying binary sequence corresponding to the set of modulation symbols, a relative modulation depth of associated with the on-off keying modulation scheme, a relative transmit power for a first modulation symbol of the set of modulation symbols with respect to a second modulation symbol of the set of modulation symbols, or a combination thereof.

4. The apparatus of claim 2, wherein:
the first modulation scheme comprises an on-off keying modulation scheme; and
the indication comprises a respective transmit power for each modulation symbol of the set of modulation symbols.

5. The apparatus of claim 2, wherein:
the first modulation scheme comprises an amplitude shift keying modulation scheme; and
the indication comprises an amplitude shift keying decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

6. The apparatus of claim 1, wherein the indication comprises one or more pilot signals associated with one or more modulation symbols of the set of modulation symbols.

7. The apparatus of claim 6, wherein the instructions are further executable by the at least one processor to cause the first wireless device to:
transmit an indication of one or more time domain resources and one or more frequency domain resources for each of the one or more pilot signals, wherein the indication of the one or more time domain resources and one or more frequency domain resources is transmitted prior to transmitting the indication of the set of modulation symbols in the first transmission.

8. The apparatus of claim 6, wherein the one or more pilot signals comprise one or more phase tracking reference signals.

9. The apparatus of claim 1, wherein:
the indication is transmitted via a set of resources of a logical channel associated with indicating an on-off keying binary sequence for the set of modulation symbols; and
the set of resources includes a quantity of frequency domain resources that is based at least in part on a quantity of symbols of the set of modulation symbols.

10. The apparatus of claim 9, wherein:
the multiplexed waveform is within a slot; and
the set of resources of the indication includes an initial time domain resource of the slot.

11. The apparatus of claim 9, wherein:
the multiplexed waveform is within a first slot; and
the set of resources of the indication includes a final time domain resource of a second slot prior to the first slot.

12. The apparatus of claim 1, wherein the instructions to transmit the indication are executable by the at least one processor to cause the first wireless device to:
transmit downlink control information having a format associated with a preemption indication.

13. The apparatus of claim 1, wherein the instructions to transmit the indication are executable by the at least one processor to cause the first wireless device to:
transmit uplink control information having a format associated with a preemption indication.

14. The apparatus of claim 1, wherein the third wireless device is a passive device and the first wireless device is a reader node associated with reading the passive device.

15. An apparatus for wireless communications at a second wireless device, comprising:
at least one processor; and
memory coupled with the at least one processor, the memory storing instructions executable by the at least one processor to cause the second wireless device to:
receive, from a first wireless device, an indication of a set of modulation symbols in a first transmission to a third wireless device using a first modulation scheme, wherein the first transmission is scheduled to at least partially overlap with a second transmission to the second wireless device using a second modulation scheme; and
receive, in accordance with the indication, a multiplexed waveform comprising the first transmission according to the first modulation scheme multiplexed with at least a portion of the second transmission according to the second modulation scheme.

16. The apparatus of claim 15, wherein the indication is received prior to receiving the multiplexed waveform.

17. The apparatus of claim 16, wherein:
the first modulation scheme comprises an on-off keying modulation scheme; and
the indication comprises an on-off keying binary sequence corresponding to the set of modulation symbols, a relative modulation depth of associated with the on-off keying modulation scheme, a relative transmit power for a first modulation symbol of the set of modulation symbols with respect to a second modulation symbol of the set of modulation symbols, or a combination thereof.

18. The apparatus of claim 16, wherein:
the first modulation scheme comprises an on-off keying modulation scheme; and
the indication comprises a respective transmit power for each modulation symbol of the set of modulation symbols.

19. The apparatus of claim 16, wherein:
the first modulation scheme comprises an amplitude shift keying modulation scheme; and
the indication comprises an amplitude shift keying decimal sequence for the set of modulation symbols, a relative modulation depth for a first modulation symbol of the set of modulation symbols with respect to a second modulation symbol of the set of modulation symbols, a relative transmit power for a first modulation symbol of the set of modulation symbols with respect to a second modulation symbol of the set of modulation symbols, or a combination thereof.

20.-28. (canceled)

29. A method for wireless communications at a first wireless device, comprising:
transmitting, to a second wireless device, an indication of a set of modulation symbols in a first transmission to a third wireless device using a first modulation scheme, wherein the first transmission is scheduled to at least partially overlap with a second transmission to the second wireless device using a second modulation scheme; and
transmitting, in accordance with the indication, a multiplexed waveform comprising the first transmission according to the first modulation scheme multiplexed with at least a portion of the second transmission according to the second modulation scheme.

30. (canceled)
